(19) United States
(12) Patent Application Publication
(10) Pub. No.: US 2026/0300253 A1
(43) Pub. Date: Oct. 1, 2026

(54) METHOD, DEVICE, AND MEDIUM FOR INFORMATION PROCESSING

(71) Applicant: Bytedance Technology Ltd., Grand Cayman (KY)

(72) Inventors: Yujian KANG, Beijing (CN); Wei ZHAO, Beijing (CN)

(21) Appl. No.: 19/629,948

(22) Filed: Mar. 26, 2026

(30) Foreign Application Priority Data
Mar. 27, 2025 (CN) 202510376454.7

(51) Int. Cl. G06F 16/23

(52) U.S. Cl. CPC G06F 16/235

(57) ABSTRACT

The present disclosure is directed to information processing. A method includes: receiving a strategy update request for a comment, which includes a first evaluation strategy for the comment by a first service party of a plurality of service parties; obtaining at least one second evaluation strategy for the comment by at least one second service party of plurality of service parties, an evaluation strategy indicating an evaluation result of a state of the comment; determining, based on state weights corresponding to the first evaluation strategy and to the at least one second evaluation strategy, a target evaluation strategy from the first evaluation strategy and the at least one second evaluation strategy, each state weight indicating a degree of state constraint on the comment by a corresponding evaluation strategy; and configuring the state of the comment based on the target evaluation strategy.

### CROSS-REFERENCE

The present disclosure claims priority to Chinese Patent Application No. 202510376454.7 filed on Mar. 27, 2025, and entitled “METHOD, APPARATUS, DEVICE, MEDIUM AND PROGRAM PRODUCT FOR INFORMATION PROCESSING”.

### FIELD

Example embodiments of the present disclosure generally relate to the field of computers and in particular, to a method, an apparatus, a device, a computer-readable storage medium, and a computer program product for information processing.

### BACKGROUND

In the current era of extremely frequent digital information interaction, with the booming development of social applications, online forums, and various content platforms, a user comment function has become an important part of information exchange and interaction. Those comments may serve as an important way for users to express their opinions and feedback experiences, and their presentation state (such as a visibility state, a sorting state, and the like) play a key role in users' access to effective information and platform operation management.

### SUMMARY

In a first aspect of the present disclosure, a method for information processing is provided. The method includes: receiving a strategy update request for a comment, the strategy update request comprising a first evaluation strategy for the comment by a first service party of a plurality of service parties; obtaining, in response to the strategy update request, at least one second evaluation strategy for the comment by at least one second service party of the plurality of service parties, each of the first evaluation strategy and the at least one second evaluation strategy indicating an evaluation result of a state of the comment; determining, based on state weights corresponding to the first evaluation strategy and to the at least one second evaluation strategy, a target evaluation strategy from the first evaluation strategy and the at least one second evaluation strategy, each state weight indicating a degree of state constraint on the comment by a corresponding evaluation strategy; and configuring the state of the comment based on the target evaluation strategy.

In a second aspect of the present disclosure, an apparatus for information processing is provided. The apparatus includes: a receiving module configured to receive the strategy update request for the comment, the strategy update request comprising the first evaluation strategy for the comment by the first service party of the plurality of service parties; an obtaining module configured to obtain, in response to the strategy update request, at least one second evaluation strategy for the comment by at least one second service party of the plurality of service parties, each of the first evaluation strategy and at least one second evaluation strategy indicating the evaluation result of the state of the comment; a determining module configured to determine, based on state weights corresponding to the first evaluation strategy and to the at least one second evaluation strategy, the target evaluation strategy from the first evaluation strategy and the at least one second evaluation strategy, each state weight indicating the degree of state constraint on the comment by the corresponding evaluation strategy; and a configuring module configured to configure the state of the comment based on the target evaluation strategy.

In a third aspect of the present disclosure, an electronic device is provided. The device includes at least one processor; and at least one memory coupled to the at least one processor and storing instructions executable by the at least one processor. The instructions, when executed by the at least one processor, cause the device to perform the method of the first aspect.

In a fourth aspect of the present disclosure, a computer-readable storage medium is provided. The medium has computer-executable instructions stored thereon, the computer-executable instructions, when executed by a processor, implementing the method of the first aspect.

In a fifth aspect of the present disclosure, a computer program product is provided. The computer program product is tangibly stored in a computer storage medium and includes computer-executable instructions, the computer-executable instructions, when executed by a device, causing the device to perform the method of the first aspect.

It would be appreciated that content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. The same or similar reference symbols refer to the same or similar elements in the accompanying drawings, where:

FIG. 1 illustrates a schematic diagram of an example environment in which the embodiments of the present disclosure may be implemented;

FIG. 2 illustrates a flowchart of a process for information processing according to some embodiments of the present disclosure;

FIG. 3 illustrates a flowchart of an example process for information processing according to some embodiments of the present disclosure;

FIG. 4 illustrates a schematic structural block diagram of an example apparatus for information processing according to some embodiments of the present disclosure; and

FIG. 5 illustrates a block diagram of an electronic device in which one or more embodiments of the present disclosure may be implemented.

### DETAILED DESCRIPTION OF EMBODIMENTS

The embodiments of the present disclosure will be described in more detail below with reference to the accompanying drawings. While certain embodiments of the present disclosure are shown in the accompanying drawings, it should be appreciated that the present disclosure may be implemented in various forms, and should not be illustrated as limiting to the embodiments set forth herein. But rather, these embodiments are provided for a more thorough and complete understanding of the present disclosure. It should be appreciated that the accompanying drawings and embodiments of the present disclosure are for illustrative purposes only, and are not intended to limit the scope of protection of the present disclosure.

It should be noted that the titles of any sections/subsections provided herein are not intended to be limiting. Various embodiments are described throughout the text, and any type of embodiments may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and similar terms thereto should be understood as open-ended inclusions, i.e., “include/comprise but not limited to”. The term “based on” should be understood as “based at least in part on”. The term “one embodiment” or “the embodiment” should be understood as “at least one embodiment”. The term “some embodiments” should be understood as “at least some embodiments”. Other definitions, either explicit or implicit, may also be included below. The terms “first” and “second” may refer to different or same objects. Other definitions, either explicit or implicit, may also be included below.

The embodiments of the present disclosure may involve the data of a user, acquisition and/or use of data, and the like. These aspects all follow with corresponding laws, regulations, and related provisions. In the embodiments of the present disclosure, collection, acquisition, processing, refinement, forwarding, using, and the like of data are all performed on the premise that the user is aware of and confirms. Accordingly, when implementing the embodiments of the present disclosure, the type, usage scope, usage scenario, and the like, of data or information that may be involved should be notified to the user and the authorization of the user should be obtained in an appropriate manner in accordance with relevant laws and regulations. The specific manner of notification and/or authorization may vary according to the actual situation and application scenarios, and the scope of the present disclosure is not limited in this respect.

The solutions in this specification and the embodiments, if personal information processing is involved, may perform processing on premise of having a legality basis(for example, obtaining the consent of the personal information subject, or it is necessary to perform a fulfillment contract, and the like), and processing only within the scope of provisions or agreements. The rejection of the user on processing personal information other than necessary information required by basic functions would not affect the use of the basic functions by the user.

For example, prompt information is sent, in response to receiving an active request from a user to the user to clearly prompt the user that the requested operation will require obtaining and using of the personal information of the user, so that the user may independently choose, according to the prompt information, whether to provide the personal information to software or hardware, such as an electronic device, an application, a server, or a storage medium, that performs the operations of the technical solution of the present disclosure.

As an optional but non-limiting implementation, the prompt information may be sent, in response to receiving the active request from the user, to the user in the form of, for example, a pop-up window, in which the prompt information may be presented in text. In addition, the pop-up window may also carry a selection control for the user to choose either “agree” or “disagree” to provide the personal information to the electronic device.

It would be appreciated that the above process of notifying and obtaining user authorization is illustrative only, and does not constitute a limitation on the implementations of the present disclosure. Other manners that comply the relevant laws and regulations may also be applied to the implementations of the present disclosure.

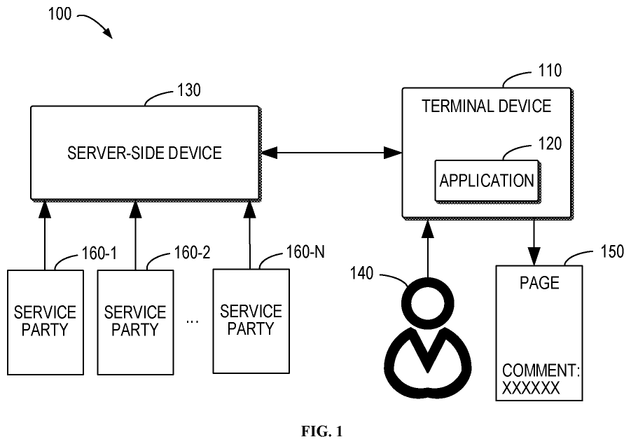

FIG. 1 illustrates a schematic diagram of an example environment 100 in which the embodiments of the present disclosure may be implemented. The example environment 100 may include a terminal device 110. In some embodiments, an application 120 may be installed in the terminal device 110, and the application 120 may include, for example, a social application, online forum, and any of various content platforms, and the like.

In some embodiments, the terminal device 110 may present a corresponding page 150 of the application 120, and the page 150 may display, for example, media content and interactive information such as comments of a user 140 on the media content. As an example, the media content may include, for example, a video, an audio, an image, text, and other content published on the application 120.

The example environment 100 may also include a server-side device 130. In some embodiments, the server-side device 130 communicates with the terminal device 110 to implement provision of a plurality of types of services for the application 120, such as a media content presentation service, a comment interaction service, and a comment management service, and the like. In some embodiments, service parties 160-1, 160-2, ..., 160-N may implement management of comments in the page 150 through the server-side device 130. As an example, these service parties may evaluate the comments based on their respective strategies, for example, evaluate the visibility state, the sorting state, any other states of the comments, and the like.

The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a Personal Communication System (PCS) device, a personal navigation device, a Personal Digital Assistant (PDA), an audio/video player, a digital camera/video camera, a positioning device, a television receiver, a radio broadcast receiver, an e-book device, a gaming device, or any combination thereof, including the accessories and peripherals of these devices, or any combination thereof. In some embodiments, the terminal device 110 may also support any type of interface (such as “wearable” circuitry, etc.) for the user.

The server-side device 130 may be an independent physical server, or may also be a server cluster or distributed system with a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network, and a big data and artificial intelligence platform. The server-side device 130 may include, for example, a computing system/server, such as a mainframe, an edge computing node, a computing device in a cloud environment, and so on. The server-side device 130 may provide a background service for the application 120 in the terminal device 110.

A communication connection may be established between the server-side device 130 and the terminal device 110. The communication connection may be established in a wired or wireless manner. The communication connection may include but be not limited to a Bluetooth connection, a mobile network connection, a Universal Serial Bus (USB) connection, a Wireless Fidelity (Wi-Fi) connection, and the like, and the embodiments of the present disclosure are not limited in this regard. In the embodiments of the present disclosure, the server-side device 130 and the terminal device 110 may implement signaling interaction through the communication connection therebetween.

It should be appreciated that the structure and functions of the individual elements in the environment 100 are described for illustrative purposes only, without suggesting any limitation to the scope of the present disclosure.

As briefly mentioned above, with the booming development of social applications, online forums, and various content platforms, the user comment function has become an important part of information exchange and interaction. In the current Internet comment management system, there may be a plurality of service parties evaluating the state of the comment from different perspectives or for different management strategies. Comment evaluation by the plurality of service parties may not be performed at the same time, or the same service party may re-evaluate the same comment due to some triggering events. Currently, the state of a comment, such as its visibility state, sorting state and the like, is mainly updated chronologically. When the plurality of service parties propose different state processing suggestions for the same comment, a suggestion of a service party submitted later will override all suggestions of previous service parties, resulting in the processing suggestions of some service parties in history being lost. For example, when a service party A suggests configuring the visibility state of the comment to “only visible to the user”, while a subsequent service party B suggests that the visibility state of the comment is “visible to all”, a suggestion of the service party B will override the previous suggestion of the service party A. However, these processing suggestions are often of great significance to the service parties, for example, involving quality assessment of user comments, content compliance review, and the like. Therefore, the current comment state update mechanism cannot effectively guarantee the persistence and integrity of the comment state processing by each of the service parties, affecting the effectiveness of the comment management system.

The current comment state update mechanism has various defects in processing comment state update requests from different service parties. First, due to the use of chronological overwriting updates, a processing suggestion submitted earlier is likely to be replaced by a subsequent suggestion in a subsequent update, resulting in that historical processing suggestions cannot be effectively recorded and retained, and thus the processing suggestion will be lost. Second, different service parties may provide suggestions for processing the comment based on different business logics and requirements, and it is difficult for the current comment state update mechanism to fully consider the suggestions of each of the service parties, resulting in that the processing suggestions of part of service parties cannot be reflected and performed. In addition, the current comment state update mechanism results in a lack of an effective coordination and integration mechanism for the processing suggestions of each of the service parties in the update process, and thus conflicts and inconsistencies may easily occur, affecting the overall effect of comment state management.

In view of the above, embodiments of the present disclosure propose a solution for information processing. According to this solution, a strategy update request for the comment by a first service party of a plurality of service parties is received, the strategy update request including the first evaluation strategy for the comment by the first service party. In response to the strategy update request, at least one second evaluation strategy for the comment by at least one second service party of the plurality of service parties is obtained, each of the first evaluation strategy and the at least one second evaluation strategy indicating an evaluation result of a state of the comment. Based on respective state weights corresponding to the first evaluation strategy and to the at least one second evaluation strategy, a target evaluation strategy is determined from the first evaluation strategy and the at least one second evaluation strategy, each state weight indicating a degree of state constraint on the comment by the corresponding evaluation strategy. Then, the state of the comment is configured based on the target evaluation strategy.

In this way, through the embodiments of the present disclosure, after a service party initiates a strategy update request for a comment, the evaluation strategies for the comment by a plurality of service parties can be considered comprehensively, so as to select a target evaluation strategy, and configure the state for the comment according to the target evaluation strategy. In this way, the business requirements of each of the service parties can be considered more comprehensively when configuring the comment state, and important evaluation strategies for the comment may be avoided to be lost, thereby improving decision accuracy and decision quality. This further ensures the effectiveness and integrity of comment management. In addition, the solution of the present disclosure may adapt to diverse requirements in different business scenarios, and may enhance the flexibility and expandability of the comment management system.

Some example embodiments of the present disclosure will be further described below with reference to the accompanying drawings.

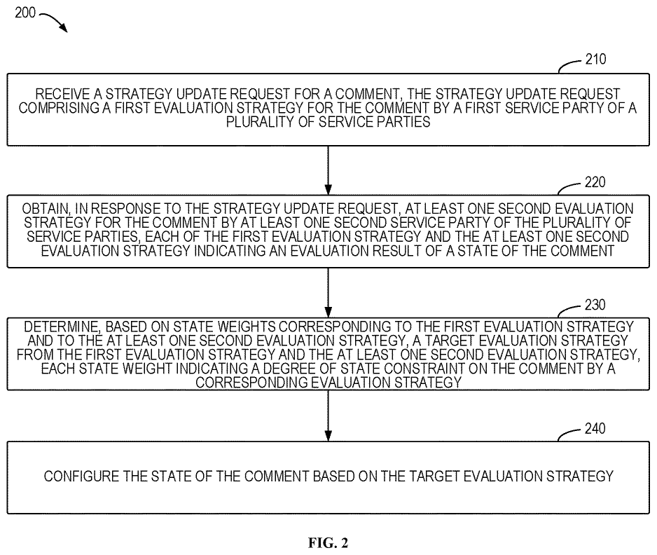

FIG. 2 illustrates a flowchart of a process 200 for information processing according to some embodiments of the present disclosure. For ease of discussion, these embodiments will be described with reference to the environment 100 of FIG. 1. These embodiments may be implemented at the server-side device 130 of FIG. 1.

At block 210, the server-side device 130 receives a strategy update request for a comment. As an example, the comment may be, for example, a comment posted by the user 140 in the application 120 on media content such as a video, an audio, an image, a text, and the like. In other examples, the comment may also be a related comment on any other appropriate content in the application 120, which is not limited here. It would be appreciated that the content of the comment and the evaluation process of the comment comply with requirements of relevant laws and regulations.

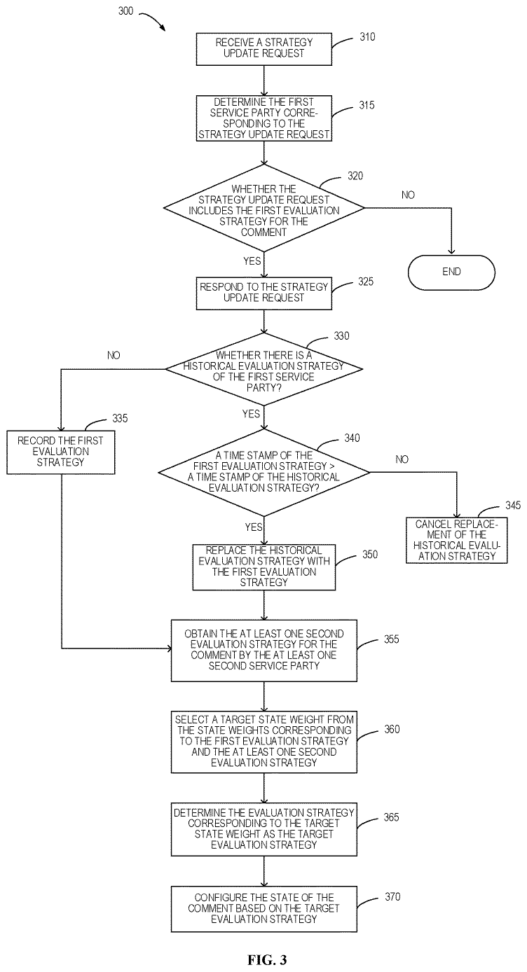

In some embodiments, the strategy update request for the comment may be a strategy update request issued by a certain service party of a plurality of service parties for the comment. As an example, the strategy update request may be a request for a strategy update service made by the service party for the state of the comment or other aspects of the comment other than the state. As an example, the service party may update or create a strategy for the comment, such as the strategy for the state or other aspects, according to its own business requirements. In order to determine how to determine a related configuration for the comment after the service party issues the strategy update request for the comment, it is necessary to determine which service party among the plurality of service parties issues the strategy update request, and what aspect of the comment the content included in the strategy update request is about. How to determine the service party that issues the strategy update request, determine the strategy for the comment included in the strategy update request, and then determine the configuration for the comment will be discussed in detail below with reference to FIG. 3.

In the process 200, the strategy update request includes a first evaluation strategy on the comment by a first service party of the plurality of service parties. The evaluation strategy indicates an evaluation result of a state of the comment.

In some embodiments, the state of the comment may include a visibility state or a sorting state. The visibility state of the comment may include, for example, that the comment is “only visible to the user”, “only visible to friends”, “visible to all”, and so on. The first evaluation strategy on the comment by the first service party may indicate, for example, that the evaluation result of the visibility state of the comment may be “only visible to the user” or may be any of the other evaluation results. The sorting state of the comment may include, for example, that the comment is ranked at the top position, that the comment is ranked in a front position according to a popularity degree of interaction on the comment, that the comment is ranked in a corresponding position according to a commenting time, that the comment is preferentially ranked in the front position according to an attention degree to the user who releases the commented media content, and so on. The first evaluation strategy on the comment by the first service party may indicate, for example, that the evaluation result of the sorting state of the comment may be “ranking the comment at the top position” , “sorting by the sending time”, or may be any of the other evaluation results. It should be appreciated that the above examples of the visibility state and the sorting state of the comment are only given for ease of understanding, without suggesting any limitation, and there may be any other suitable visibility states and sorting states of the comment in a practical application.

In other embodiments, the state of the comment may also include any other suitable state, such as a marked state, and so on. For example, the service party may mark an important comment as a high-quality comment, and so on. Therefore, the state of the comment may be set according to the practical application requirement, without suggesting any limitation here.

At block 220, the server-side device 130 obtains, in response to the strategy update request, at least one second evaluation strategy for the comment by at least one second service party of the plurality of service parties. Each of the at least one second evaluation strategy indicates the evaluation result of the state of the comment.

For example, the service party may determine an evaluation strategy for the comment according to its own business requirements. As an embodiment, different service parties may determine evaluation strategies for the comment according to their different business requirements. For example, for the visibility state of the comment, a service party A may determine an evaluation result of “only visible to friends” for the comment, a service party B may give an evaluation result of “only visible to the user” for the comment, and so on. Certainly, different service parties may also determine the same evaluation strategy for the comment. For example, for the sorting state of the comment, both a service party C and a service party D determine an evaluation result of ranking first for the comment.

In some embodiments, to obtain the at least one second evaluation strategy for the comment by the at least one second service party of the plurality of service parties, the server-side device 130 may extract the at least one second evaluation strategy for the comment by the at least one second service party from an evaluation strategy table corresponding to the comment. The evaluation strategy table may at least include the at least one second evaluation strategy and a corresponding time stamp of the at least one second service party. As an example, each comment may have a corresponding evaluation strategy table. The evaluation strategy table of the comment may also be referred to as a historical decision record table. As an example, the latest evaluation strategy/strategies of the service party may be stored in the evaluation strategy table. Accordingly, when the server-side device 130 responds to the strategy update request, the at least one second evaluation strategy in the evaluation strategy table may be the latest evaluation strategy/strategies for the comment by the at least one second service party.

In order to reduce occupancy of storage space for storing the evaluation strategy of the service party, in some embodiments, the evaluation strategy table may include a field set for each evaluation strategy. That is, by means of compression encoding, relevant information of each evaluation strategy may be collected in the field set in a manner of field encoding. As an example, a service separator may be used to separate fields of the plurality of service parties in the field set, and a field separator may also be used to separate a plurality of fields of each service party. The service separator and the field separator may be any appropriate characters, symbols, etc., which are different from each other, and are not limited here. For example, a semicolon may be used to represent the service separator, a comma may be used to represent the field separator, or other suitable characters or symbols may be used to represent the service separator and the field separator, respectively.

In some embodiments, the field set may include a time stamp field corresponding to the evaluation strategy and at least one of the following: an identification field of the comment, an identification field of the state of the comment, an identification field of the service party corresponding to the evaluation strategy, and an update cause field corresponding to the evaluation strategy. These fields may be separated by the service separator. Specific field content of these fields may be, for example, a JSON field, or other any suitable fields that may respectively represent the identification of the comment, the identification of the state of the comment, the identification of the service party corresponding to the evaluation strategy, and the update cause corresponding to the evaluation strategy, which may be set according to the practical application, and are not limited here. As an example, these fields may have corresponding positions in the plurality of fields of each service party respectively, so as to determine a specific meaning represented by corresponding field content according to the position.

At a block 230, the server-side device 130 determines, based on state weights corresponding to the first evaluation strategy and to the at least one second evaluation strategy, the target evaluation strategy from the first evaluation strategy and the at least one second evaluation strategy. Each state weight indicates a degree of state constraint on the comment by the corresponding evaluation strategy. In other words, the state weight may represent a degree of strictness of the corresponding evaluation strategy on the state of the comment.

As an example, the value of the state weight may be positively correlated with the size of the degree of state constraint (or the degree of strictness) on the comment. For example, the greater the state weight is, the greater the degree of state constraint is on the comment, or the stricter the state of the comment. For example, assuming that an evaluation strategy A indicates that the evaluation result A of the visibility state of the comment is “only visible to the user”, and an evaluation strategy B indicates that the evaluation result B of the visibility state of the comment is “only visible to friends”, then the evaluation result A is stricter with a higher degree of constraint, and has a greater weight as compared to the evaluation result B. Assuming that an evaluation strategy C indicates that the evaluation result C of the sorting state of the comment is that the comment is ranked at a top position, and an evaluation strategy D indicates that the evaluation result D of the sorting state of the comment is that the comment is ranked in the corresponding position according to the commenting time, then the evaluation result C is stricter with a higher degree of constraint, and has a greater weight as compared to the evaluation result D. It should be appreciated that the state constraint degrees of different states may be configured according to the practical application. For example, the state of “only visible to friends” may be configured to have a higher degree of constraint or a higher degree of strictness than the state of “only visible to the user”, and the same is true for the sorting state. The embodiments of the present disclosure are not specifically limited in this respect.

Therefore, the target evaluation strategy may be determined from the first evaluation strategy and the at least one second evaluation strategy according to the respective values of the state weights corresponding to the first evaluation strategy and to the at least one second evaluation strategy. How to determine the target evaluation strategy based on the state weights corresponding to the first evaluation strategy and to the at least one second evaluation strategy will be discussed in detail below with reference to FIG. 3.

At block 240, the server-side device 130 configures the state of the comment based on the target evaluation strategy. For example, assuming that the target evaluation strategy for the visibility state of the comment is “only visible to the user”, the visibility state of the comment may be configured to be “only visible to the user”. Assuming that the target evaluation strategy for the sorting state of the comment is “ranking the comment at the top position”, then the sorting state of the comment may be configured to be ranked at the top position.

In this way, the solution of the present disclosure not only considers the evaluation strategy of a current service party, but also performs comprehensive analysis in combination with the evaluation strategies of other service parties in history. Through the management of historical evaluation strategies and weight comparison corresponding to the plurality of evaluation strategies of the plurality of service parties, a comprehensive decision on the comment state may be implemented. This is different from the current solution in which the comment state is updated only chronologically. The solution of the present disclosure may effectively avoid the loss of important historical decisions.

FIG. 3 illustrates a flowchart of an example process 300 for information processing according to some embodiments of the present disclosure. The process 300 may be implemented in the environment 100 of FIG. 1. The process 300 may be shown as a specific embodiment of the process 200.

As shown in FIG. 3, the server-side device 130 may determine (315) the first service party corresponding to the strategy update request after receiving (310) the strategy update request. That is, an identity of the service party that issues the strategy update request may be identified.

In some embodiments, the strategy update request may include a service identification and an update cause of the service for performing strategy update on the comment in the first service party. As an example, the service identification of the strategy update service for the comment by the service party may include, for example, a text identification, a digital identification, and the like, which is not limited here. The update cause of the strategy update service may be a specific reason why the service party makes a new evaluation strategy for the comment. In some embodiments, if the server-side device 130 receives the strategy update request, it may determine a first service party information base matching the service identification and the update cause from a plurality of service party information bases. Then, the server-side device 130 may determine, based on the first service party information base, that the service party corresponding to the strategy update request is the first service party. As an example, the service party information base may be a pre-configured service party identity information base. The service identification and the update cause in the strategy update request may be used to match the identity of the service party that issues the request through the information base of each of the plurality of service parties.

In other embodiments, the service party information base may also store information about the service party other than the service identification and the update cause. There may be other specific information capable of identifying the identity of the service party, which is not limited here. Through the service party information base, the identity of the service party may be quickly and accurately identified.

Further, the server-side device 130 may determine (320) whether the strategy update request includes the first evaluation strategy for the comment by the first service party of the plurality of service parties. The first evaluation strategy may indicate the evaluation result of the visibility state or the sorting state of the comment. For example, the first evaluation strategy may indicate that the evaluation result of the visibility state of the comment may be, for example, “only visible to the user” or may be other evaluation results. As a further example, the first evaluation strategy may indicate that the evaluation result of the sorting state of the comment may be, for example, “ranking the comment at the top position”, or any of other evaluation results.

If the strategy update request does not include the first evaluation strategy for the comment, the process ends. As an example, if the strategy update request is the request for the update service of the strategy made by the service party for other aspects of the comment other than the state, the server-side device 130 may directly execute such a request. It should be appreciated that when the strategy update request does not include an evaluation strategy for the state of the comment, the process may end.

Further, if the strategy update request includes the first evaluation strategy for the comment by the first service party of the plurality of service parties, the server-side device 130 responds (325) to the strategy update request. In some embodiments, the strategy update request may further include a time stamp corresponding to the first evaluation strategy. After the server-side device 130 responds to the strategy update request, it may be determined (330) whether there is a historical evaluation strategy for the comment by the first service party. The time stamp corresponding to the historical evaluation strategy is earlier than the time stamp corresponding to the first evaluation strategy.

In some embodiments, the evaluation strategy and the corresponding time stamp of each service party for the comment may be recorded in the evaluation strategy table. As an example, each comment may have a corresponding evaluation strategy table. The evaluation strategy table of the comment may also be referred to as a historical decision record table.

In some embodiments, after responding to the strategy update request, the server-side device 130 may determine whether the evaluation strategy table corresponding to the comment includes the historical evaluation strategy for the comment by the first service party. As an example, the latest evaluation strategy of each service party may be recorded in the evaluation strategy table of the comment.

If the evaluation strategy table does not include the historical evaluation strategy of the first service party, the server-side device 130 may record (335) the first evaluation strategy for the comment and the corresponding time stamp of the first service party in an evaluation strategy table.

In some embodiments, when recording the first evaluation strategy and the corresponding time stamp of the first service party in the evaluation strategy table, the server-side device 130 may determine whether the number of a plurality of evaluation strategies in the evaluation strategy table exceeds a number threshold. As an example, the number threshold (for example, 5 or other number threshold) corresponding to the number of evaluation strategies that may be recorded in the evaluation strategy table may be set according to the size of the storage capacity corresponding to the evaluation strategy table.

If the number of the plurality of evaluation strategies in the evaluation strategy table does not exceed the number threshold, the server-side device 130 may record the first evaluation strategy and the corresponding time stamp of the first service party in the evaluation strategy table. If the number of the plurality of evaluation strategies in the evaluation strategy table exceeds the number threshold, the server-side device 130 may remove part of the plurality of evaluation strategies and corresponding time stamps from the evaluation strategy table based on a removal rule. The removal rule may be determined based on respective state weights corresponding to the plurality of evaluation strategies.

In some embodiments, if the number of the plurality of evaluation strategies in the evaluation strategy table exceeds the number threshold, the removal rule may include determining a difference between the number of the plurality of evaluation strategies in the evaluation strategy table and the number threshold, determining, from the evaluation policy table, part of evaluation strategies with smaller state weights corresponding to the number of the difference, and removing the part of the evaluation strategies and the corresponding time stamps from the evaluation strategy table. In such embodiments, when a new evaluation strategy (which may also be referred to as a decision) needs to be recorded, a record with the least strictness may be eliminated according to such a predetermined removal rule, so as to remove historical data and reduce the storage consumption.

In order to remove part of the plurality of evaluation strategies and the corresponding time stamps from the evaluation strategy table, the server-side device 130 may select at least one state weight, which indicates a degree of state constraint not satisfying a first state constraint threshold, from the respective state weights corresponding to the plurality of evaluation strategies, and remove an evaluation strategy corresponding to each of the at least one state weight from the evaluation strategy table. As an example, the first state constraint threshold may be a predetermined specific value or be within a predetermined value range. Different from the removal rule in which the evaluation strategies to be removed may be determined based on the number of the difference in the above embodiments, the removal rule in this embodiment is that an evaluation strategy to be removed may be determined based on a comparison between the degree of state constraint indicated by the state weight corresponding to the evaluation strategy and the first state constraint threshold. When recording a new evaluation strategy, historical evaluation strategies are removed using the predetermined removal rule, which may reduce the content security risk caused by storing a large scale of historical data and may also reduce the storage consumption. Compared with the traditional storage method, this recording method is more efficient and secure.

In other embodiments, the evaluation strategy to be removed and the corresponding time stamp may also be determined based on the value of each of the time stamps in the evaluation strategy table. For example, an evaluation strategy with a smaller time stamp (that is, an earlier time) may be removed, and so on. Therefore, through these embodiments, removing the evaluation strategy from the evaluation strategy table may ensure that an effective decision is made on the comment state to be configured by using the remaining evaluation strategies in the evaluation strategy table, and may also keep the evaluation strategies as time-efficient. Therefore, after some evaluation strategies are removed from the evaluation strategy table, the first evaluation strategy may be recorded (335) in the evaluation strategy table.

In some embodiments, the server-side device 130 may further determine (340) whether the time stamp of the first evaluation strategy of the first service party is greater than the time stamp of the historical evaluation strategy. If the evaluation strategy table includes the historical evaluation strategy of the first service party, and the time stamp of the first evaluation strategy is greater than the time stamp of the historical evaluation strategy, the server-side device 130 may replace (350) the historical evaluation strategy and its corresponding time stamp with the first evaluation strategy and its corresponding time stamp, respectively, in the evaluation strategy table. In this way, the first evaluation strategy of the first service party recorded in the evaluation strategy table is the latest evaluation strategy of the first service party. On the contrary, if the time stamp of the first evaluation strategy is less than or equal to the time stamp of the historical evaluation strategy, cancel the replacement of the historical evaluation strategy and the corresponding time stamp(345).

Further, the server-side device 130 obtains (355) the at least one second evaluation strategy for the comment from at least one second service party of the plurality of service parties, and determines a target evaluation strategy from the first evaluation strategy and the at least one second evaluation strategy. In some embodiments, in order to determine the target evaluation strategy from the first evaluation strategy and the at least one second evaluation strategy, the server-side device 130 may select (360) a target state weight with the degree of state constraint exceeding a state constraint threshold, from the plurality of state weights corresponding to the first evaluation strategy and the at least one second evaluation strategy, respectively. As an example, the state constraint threshold may be a predetermined larger value, or may be within a predetermined larger value range, so as to represent a stricter degree of state constraint.

In some other embodiments, the server-side device 130 may also directly select the greatest state weight as the target state weight from the plurality of state weights corresponding to the first evaluation strategy and the at least one second evaluation strategy, respectively. Therefore, in the embodiments of the present disclosure, each comment state is assigned with a weight of degree of strict constraint, and the strictest decision is selected as the final comment state through the comparison and sorting of decision combinations of the plurality of evaluation strategies of the plurality of service parties. This weight-based decision combination may ensure that the strictest business decision is always effective, and guarantee the rigorousness and effectiveness of comment state management.

Further, the server-side device 130 may determine (365) the first evaluation strategy or the second evaluation strategy corresponding to the target state weight as the target evaluation strategy. Then, the server-side device 130 configures (370) the state of the comment based on the target evaluation strategy. For example, assuming that the target evaluation strategy for the visibility state of the comment is “only visible to the user”, the state of the comment may be configured to be “only visible to the user”. For a further example, assuming that the target evaluation strategy for the sorting state of the comment is “ranking the comment at the top position”, the sorting state of the comment may be configured to be ranked at a top position. As an example, a new configuration result of the comment state may be fed back to the plurality of service parties for display and management.

In this way, through the embodiments of the present disclosure, after a service party initiates a strategy update request for a comment, it is possible to comprehensively consider the evaluation strategies for the comment by a plurality of service parties, so as to select a target evaluation strategy and configure the state for the comment according to the target evaluation strategy. In this way, the business requirements of each of the service parties may be considered more comprehensively when configuring the comment state, and important evaluation strategies for the comment may be avoided to be lost, thereby improving decision accuracy and decision quality. This further ensures the effectiveness and integrity of comment management. In addition, the solution of the present disclosure may adapt to diverse requirements in different business scenarios, and may enhance the flexibility and expandability of the comment management system.

In addition, an embodiment of the present disclosure further provides an information processing system, which may include a service identification module configured to receive the strategy update request for the comment and identify the identity of the service party. The system may further include a state update decision module configured to determine whether the strategy update request includes an update of the comment state. The system may further include a historical evaluation strategy management module configured to store and manage historical evaluation strategies of the service parties. The system may further include a decision combination module configured to combine the evaluation strategies of the plurality of service parties and obtain the final comment state. The system may further include a control execution module configured to perform an update operation according to the final comment state and feed back the configuration result. Through the integration and collaborative work of these modules, efficient management of comment state update may be achieved.

Through the embodiments of the present disclosure, the accuracy and integrity of decision making on the evaluation strategy for the comment may be improved. The Business requirements and logics of each party may be reflected fully through comprehensively considering the historical decisions and the current decisions of the plurality of service parties, thereby improving the accuracy and integrity of decision making on the comment state. In addition, it may avoid losing decisions of service parties caused by the chronological overwriting update method, ensuring that the processing suggestion of each service party may be fully considered and reflected. Further, by assigning each comment state the weight of the degree of strictness constraint and selecting the strictest decision as the final comment state through comparison and sorting of decision combination, it may be ensured that the strictest business decision is always effective, and the rigorousness and effectiveness of comment state management are guaranteed. Furthermore, the storage costs and security risks may be reduced, the demand for storage space is effectively reduced through the use of compression encoding and removal mechanism. while the content security risk caused by storing a large amount of historical data is reduced, which is more efficient and secure.

In addition, in the embodiments of the present disclosure, a target state weight is selected according to the plurality of state weights corresponding to the plurality of evaluation strategies of the plurality of service parties, and then the configuration of the state of the comment is determined according to the target evaluation strategy corresponding to the target state weight, which may avoid relying on specific business logics of the individual service parties in the decision-making process. Therefore, even in the case where more service parties are involved in evaluating a comment, the solution of the present disclosure may adapt to diverse requirements of the individual service parties in evaluating the comment in different business scenarios, which enhances the flexibility and expandability of the information processing system. In addition, the updated comment state may be monitored to ensure that it meets the expectations of the service parties and the security requirements of the system, which may add a continuous monitoring function for the comment on the original basis, to further improve the stability and reliability of the system.

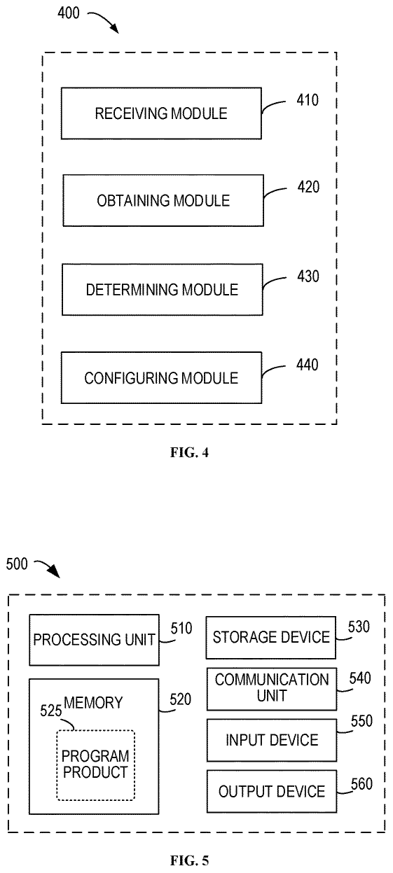

The embodiments of the present disclosure further provide a corresponding apparatus for implementing the above method or process. FIG. 4 illustrates a schematic structural block diagram of an example apparatus 400 for information processing according to some embodiments of the present disclosure. The apparatus 400 may be implemented as or included in the server-side device 130. Each module/component in the apparatus 400 may be implemented in hardware, software, firmware, or any combination thereof.

As shown in the figure, the apparatus 400 comprises a receiving module 410 configured to receive a strategy update request for a comment, the strategy update request comprising a first evaluation strategy for the comment by a first service party of a plurality of service parties; an obtaining module 420 configured to obtain, in response to the strategy update request, at least one second evaluation strategy for the comment by at least one second service party of the plurality of service parties, each of the first evaluation strategy and at least one second evaluation strategy indicating an evaluation result of a state of the comment; a determining module 430 configured to determine, based on state weights corresponding to the first evaluation strategy and to the at least one second evaluation strategy, a target evaluation strategy from the first evaluation strategy and the at least one second evaluation strategy, each state weight indicating a degree of state constraint on the comment by a corresponding evaluation strategy; and a configuring module 440 configured to configure the state of the comment based on the target evaluation strategy.

In some embodiments, the determining module 430 is further configured to select, from a plurality of state weights corresponding to the first evaluation strategy and the at least one second evaluation strategy, respectively, a target state weight with a degree of state constraint exceeding a state constraint threshold; and determine the first evaluation strategy or the second evaluation strategy corresponding to the target state weight as the target evaluation strategy.

In some embodiments, the obtaining module 420 is further configured to extract, from an evaluation strategy table corresponding to the comment, at least one second evaluation strategy for the comment by the at least one second service party, the evaluation strategy table comprising at least the at least one second evaluation strategy of the at least one second service party and a corresponding time stamp.

In some embodiments, the strategy update request further comprises a time stamp corresponding to the first evaluation strategy, and the apparatus 400 further comprises a recording module configured to determine, in response to the strategy update request, whether the evaluation strategy table corresponding to the comment comprises a historical evaluation strategy for the comment by the first service party, the time stamp corresponding to the historical evaluation strategy being earlier than a time stamp corresponding to the first evaluation strategy; and replace, in response to the evaluation strategy table comprising the historical evaluation strategy of the first service party, the historical evaluation strategy and a corresponding time stamp with the first evaluation strategy and a corresponding time stamp, respectively, in the evaluation strategy table; or record, in response to the evaluation strategy table failing to comprise the historical evaluation strategy of the first service party, the first evaluation strategy for the comment by the first service party and the corresponding time stamp in the evaluation strategy table.

In some embodiments, the apparatus 400 is further configured to determine whether a number of a plurality of evaluation strategies in the evaluation strategy table exceeds a number threshold; and record, in response to the number of the plurality of evaluation strategies in the evaluation strategy table not exceeding the number threshold, the first evaluation strategy and the corresponding time stamp of the first service party in the evaluation strategy table; or remove, in response to the number of the plurality of evaluation strategies in the evaluation strategy table exceeding the number threshold, part of the plurality of evaluation strategies and corresponding time stamps from the evaluation strategy table based on a removal rule, the removal rule being determined based on respective state weights corresponding to the plurality of evaluation strategies.

In some embodiments, the apparatus 400 is further configured to select, from the respective state weights corresponding to the plurality of evaluation strategies, at least one state weight, which indicates a degree of state constraint not satisfying a first state constraint threshold; and remove, from the evaluation strategy table, a respective evaluation strategy corresponding to each of the at least one state weight.

In some embodiments, the strategy update request further comprises a service identification and an update cause of a service in the first service party that performs strategy update on the comment, and the apparatus 400 further comprises a service party determining module configured to determine, in response to receiving the strategy update request, a first service party information base matching the service identification and the update cause from a plurality of service party information bases; and determine, based on the first service party information base, that a service party corresponding to the strategy update request is the first service party.

In some embodiments, the evaluation strategy table comprises a field set for each evaluation strategy, and where the field set comprises at least one of: a time stamp field corresponding to the evaluation strategy, an identification field of the comment, an identification field of the state of the comment, an identification field of a service party corresponding to the evaluation strategy, and an update cause field corresponding to the evaluation strategy.

In some embodiments, a state of the comment comprises a visibility state, or a sorting state.

The modules and/or units included in the apparatus 400 may be implemented in various ways, including software, hardware, firmware, or any combination thereof. In some embodiments, one or more modules and/or units may be implemented using software and/or firmware, for example, machine-executable instructions stored on a storage medium. In addition to machine-executable instructions or as an alternative, part of or all modules and/or units in the apparatus 400 may be implemented at least partially by one or more hardware logic components. As an example, but not a limitation, exemplary types of hardware logic components that may be used include field programmable gate array (FPGA), application specific integrated circuit (ASIC), application specific standard (ASSP), system on chip (SOC), complex programmable logic device (CPLD), and so on.

FIG. 5 illustrates a block diagram of an electronic device 500 in which one or more embodiments of the present disclosure may be implemented. It would be appreciated that the electronic device 500 shown in FIG. 5 is illustrative only, and should not constitute any limitation on the functions and scope of the embodiments described herein. The server-side device 130 in FIG. 1 or the apparatus 400 in FIG. 4 may be implemented as or included in one or more electronic devices 500.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor, and may execute various processes based on the programs stored in the memory 520. In a multi-processor system, a plurality of processing units execute computer-executable instructions in parallel to enhance the parallel processing capability of the electronic device 500.

The electronic device 500 typically includes various computer storage media. Such media may be any available media that is accessible to the electronic device 500, including, but not limited to, volatile and non-volatile media, removable and non-removable media. The memory 520 may be volatile memory (for example, a register, cache, a Random Access Memory (RAM)), a non-volatile memory (such as a Read-Only Memory (ROM), Electrically Erasable Programmable Read-Only Memory (EEPROM), a flash memory), or any combination thereof. The storage device 530 may be a removable or non-removable medium, and may include a machine-readable medium such as a flash drive, a disk, or any other medium, which may be used to store information and/or data and may be accessed within the electronic device 500.

The electronic device 500 may further include other removable/non-removable, volatile/non-volatile memory media. Although not shown in FIG. 5, a disk drive for reading from or writing to a removable, non-volatile disk (such as a “floppy disk”), and an optical disk drive for reading from or writing to a removable, non-volatile optical disk may be provided. In these cases, each drive may be connected to the bus (not shown) by one or more data medium interfaces. The memory 520 may include a computer program product 525, which has one or more program modules configured to perform various methods or acts of various embodiments of the present disclosure.

The communication unit 540 implements communication with other electronic devices through the communication medium. Additionally, the functions of the components of the electronic device 500 may be implemented by a single computing cluster or a plurality of computing machines, which may communicate through communication connections. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to an exemplary implementation of the present disclosure, there is provided a computer-readable storage medium having computer-executable instructions stored thereon, where the computer-executable instructions are executed by a processor to implement the method described above. According to an exemplary implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowchart and/or block diagram may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus that implements the functions/actions specified in one or more blocks in the flowchart and/or block diagram is produced. These computer-readable program instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the functions/actions specified in one or more blocks in the flowchart and/or block diagram.

The computer-readable program instructions may be loaded onto a computer, other programmable data processing apparatus, or other devices, such that a series of operations and steps are performed on the computer, other programmable data processing apparatus, or other devices to produce a computer-implemented process, which causes the instructions executed on the computer, other programmable data processing apparatus, or other devices to implement the functions/actions specified in one or more blocks in the flowchart and/or block diagram.

The flowchart and block diagram in the drawings show the architectures, functions, and operations of the system, method, and computer program product that is possibly implemented according to plurality of implementations of the present disclosure. In this regard, each block in the flowchart or block diagram may represent a module, a program segment, or a portion of instructions, and the module, the program segment, or the portion of instructions contains one or more executable instructions for implementing the specified logical functions. In some alternative implementations, the functions marked in the blocks may also occur in an order different from that being marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that executes specified functions or actions, or may be implemented by a combination of dedicated hardware and computer instructions.

The implementations of the present disclosure have been described above, and the above description is illustrative, non-exhaustive, and not limited to the disclosed implementations. Many modifications and changes will be apparent to those of ordinary skill in the art without departing from the scope and spirit of the described implementations. The selection of terms used herein are intended to best explain the principles of the implementations, the practical applications, or improvements to the technology in the market, or to enable other persons of ordinary skill in the art to understand the implementations disclosed herein.

1. A method for information processing, comprising:
receiving a strategy update request for a comment, the strategy update request comprising a first evaluation strategy for the comment by a first service party of a plurality of service parties;
obtaining, in response to the strategy update request, at least one second evaluation strategy for the comment by at least one second service party of the plurality of service parties, each of the first evaluation strategy and the at least one second evaluation strategy indicating an evaluation result of a state of the comment;
determining, based on a plurality of state weights respectively corresponding to the first evaluation strategy and to the at least one second evaluation strategy, a target evaluation strategy from the first evaluation strategy and the at least one second evaluation strategy, each state weight indicating a degree of state constraint on the comment by a corresponding evaluation strategy; and
configuring the state of the comment based on the target evaluation strategy.

2. The method of claim 1, wherein determining a target evaluation strategy from the first evaluation strategy and the at least one second evaluation strategy comprises:
selecting, from the plurality of state weights corresponding to the first evaluation strategy and the at least one second evaluation strategy, respectively, a target state weight with a degree of state constraint exceeding a state constraint threshold; and
determining the first evaluation strategy or the second evaluation strategy corresponding to the target state weight as the target evaluation strategy.

3. The method of claim 1, wherein obtaining at least one second evaluation strategy for the comment by at least one second service party of the plurality of service parties comprises:
extracting, from an evaluation strategy table corresponding to the comment, at least one second evaluation strategy for the comment by the at least one second service party, the evaluation strategy table comprising at least the at least one second evaluation strategy of the at least one second service party and a corresponding time stamp.

4. The method of claim 1, wherein the strategy update request further comprises a time stamp corresponding to the first evaluation strategy, and wherein the method further comprises:
determining, in response to the strategy update request, whether the evaluation strategy table corresponding to the comment comprises a historical evaluation strategy for the comment by the first service party, a time stamp corresponding to the historical evaluation strategy being earlier than a time stamp corresponding to the first evaluation strategy; and
replacing, in response to the evaluation strategy table comprising the historical evaluation strategy of the first service party, the historical evaluation strategy and a corresponding time stamp with the first evaluation strategy and a corresponding time stamp, respectively, in the evaluation strategy table; or
recording, in response to the evaluation strategy table failing to comprise the historical evaluation strategy of the first service party, the first evaluation strategy for the comment by the first service party and the corresponding time stamp in the evaluation strategy table.

5. The method of claim 4, wherein recording the first evaluation strategy and a corresponding time stamp of the first service party in the evaluation strategy table comprises:
determining whether a number of a plurality of evaluation strategies in the evaluation strategy table exceeds a number threshold; and
recording, in response to the number of the plurality of evaluation strategies in the evaluation strategy table not exceeding the number threshold, the first evaluation strategy and the corresponding time stamp of the first service party in the evaluation strategy table; or
removing, in response to the number of the plurality of evaluation strategies in the evaluation strategy table exceeding the number threshold, part of the plurality of evaluation strategies and corresponding time stamps from the evaluation strategy table based on a removal rule, the removal rule being determined based on respective state weights corresponding to the plurality of evaluation strategies.

6. The method of claim 5, wherein removing part of the plurality of evaluation strategies and the corresponding time stamps from the evaluation strategy table comprises:
selecting, from the respective state weights corresponding to the plurality of evaluation strategies, at least one state weight which indicates a degree of state constraint not satisfying a first state constraint threshold; and
removing, from the evaluation strategy table, a respective evaluation strategy corresponding to each of the at least one state weight.

7. The method of claim 1, wherein the strategy update request further comprises a service identification and an update cause of a service in the first service party that performs strategy update on the comment, and
wherein the method further comprises:
determining, in response to receiving the strategy update request, a first service party information base matching the service identification and the update cause from a plurality of service party information bases; and
determining, based on the first service party information base, that a service party corresponding to the strategy update request is the first service party.

8. The method of claim 2, wherein the evaluation strategy table comprises a field set for each evaluation strategy, and wherein the field set comprises at least one of:
a time stamp field corresponding to the evaluation strategy, and
an identification field of the comment,
an identification field of the state of the comment,
an identification field of a service party corresponding to the evaluation strategy, and
an update cause field corresponding to the evaluation strategy.

9. The method of claim 1, wherein a state of the comment comprises a visibility state, or a sorting state.

10. An electronic device, comprising:
at least one processor; and
at least one memory coupled to the at least one processor, and storing instructions executable by the at least one processor, the instructions, when executed by the at least one processor, causing the electronic device to perform operations comprising:
receiving a strategy update request for a comment, the strategy update request comprising a first evaluation strategy for the comment by a first service party of a plurality of service parties;
obtaining, in response to the strategy update request, at least one second evaluation strategy for the comment by at least one second service party of the plurality of service parties, each of the first evaluation strategy and the at least one second evaluation strategy indicating an evaluation result of a state of the comment;
determining, based on a plurality of state weights respectively corresponding to the first evaluation strategy and to the at least one second evaluation strategy, a target evaluation strategy from the first evaluation strategy and the at least one second evaluation strategy, each state weight indicating a degree of state constraint on the comment by a corresponding evaluation strategy; and
configuring the state of the comment based on the target evaluation strategy.

11. The electronic device of claim 10, wherein determining a target evaluation strategy from the first evaluation strategy and the at least one second evaluation strategy comprises:
selecting, from the plurality of state weights corresponding to the first evaluation strategy and the at least one second evaluation strategy, respectively, a target state weight with a degree of state constraint exceeding a state constraint threshold; and
determining the first evaluation strategy or the second evaluation strategy corresponding to the target state weight as the target evaluation strategy.

12. The electronic device of claim 10, wherein obtaining at least one second evaluation strategy for the comment by at least one second service party of the plurality of service parties comprises:
extracting, from an evaluation strategy table corresponding to the comment, at least one second evaluation strategy for the comment by the at least one second service party, the evaluation strategy table comprising at least the at least one second evaluation strategy of the at least one second service party and a corresponding time stamp.

13. The electronic device of claim 10, wherein the strategy update request further comprises a time stamp corresponding to the first evaluation strategy, and wherein the operations further comprise:
determining, in response to the strategy update request, whether the evaluation strategy table corresponding to the comment comprises a historical evaluation strategy for the comment by the first service party, a time stamp corresponding to the historical evaluation strategy being earlier than a time stamp corresponding to the first evaluation strategy; and
replacing, in response to the evaluation strategy table comprising the historical evaluation strategy of the first service party, the historical evaluation strategy and a corresponding time stamp with the first evaluation strategy and a corresponding time stamp, respectively, in the evaluation strategy table; or
recording, in response to the evaluation strategy table failing to comprise the historical evaluation strategy of the first service party, the first evaluation strategy for the comment by the first service party and the corresponding time stamp in the evaluation strategy table.

14. The electronic device of claim 13, wherein recording the first evaluation strategy and a corresponding time stamp of the first service party in the evaluation strategy table comprises:
determining whether a number of a plurality of evaluation strategies in the evaluation strategy table exceeds a number threshold; and
recording, in response to the number of the plurality of evaluation strategies in the evaluation strategy table not exceeding the number threshold, the first evaluation strategy and the corresponding time stamp of the first service party in the evaluation strategy table; or
removing, in response to the number of the plurality of evaluation strategies in the evaluation strategy table exceeding the number threshold, part of the plurality of evaluation strategies and corresponding time stamps from the evaluation strategy table based on a removal rule, the removal rule being determined based on respective state weights corresponding to the plurality of evaluation strategies.

15. The electronic device of claim 14, wherein removing part of the plurality of evaluation strategies and the corresponding time stamps from the evaluation strategy table comprises:
selecting, from the respective state weights corresponding to the plurality of evaluation strategies, at least one state weight which indicates a degree of state constraint not satisfying a first state constraint threshold; and
removing, from the evaluation strategy table, a respective evaluation strategy corresponding to each of the at least one state weight.

16. The electronic device of claim 10, wherein the strategy update request further comprises a service identification and an update cause of a service in the first service party that performs strategy update on the comment, and
wherein the operations further comprise:
determining, in response to receiving the strategy update request, a first service party information base matching the service identification and the update cause from a plurality of service party information bases; and
determining, based on the first service party information base, that a service party corresponding to the strategy update request is the first service party.

17. The electronic device of claim 11, wherein the evaluation strategy table comprises a field set for each evaluation strategy, and wherein the field set comprises at least one of:
a time stamp field corresponding to the evaluation strategy, and
an identification field of the comment,
an identification field of the state of the comment,
an identification field of a service party corresponding to the evaluation strategy, and
an update cause field corresponding to the evaluation strategy.

18. The electronic device of claim 10, wherein a state of the comment comprises a visibility state, or a sorting state.

19. A non-transitory computer-readable storage medium having computer-executable instructions stored thereon, the computer-executable instructions being executable by a processor to perform operations comprising:
receiving a strategy update request for a comment, the strategy update request comprising a first evaluation strategy for the comment by a first service party of a plurality of service parties;
obtaining, in response to the strategy update request, at least one second evaluation strategy for the comment by at least one second service party of the plurality of service parties, each of the first evaluation strategy and the at least one second evaluation strategy indicating an evaluation result of a state of the comment;
determining, based on a plurality of state weights respectively corresponding to the first evaluation strategy and to the at least one second evaluation strategy, a target evaluation strategy from the first evaluation strategy and the at least one second evaluation strategy, each state weight indicating a degree of state constraint on the comment by a corresponding evaluation strategy; and
configuring the state of the comment based on the target evaluation strategy.

20. The non-transitory computer-readable storage medium of claim 19, wherein determining a target evaluation strategy from the first evaluation strategy and the at least one second evaluation strategy comprises:
selecting, from the plurality of state weights corresponding to the first evaluation strategy and the at least one second evaluation strategy, respectively, a target state weight with a degree of state constraint exceeding a state constraint threshold; and
determining the first evaluation strategy or the second evaluation strategy corresponding to the target state weight as the target evaluation strategy.
